(19) United States
(12) Patent Application Publication
(10) Pub. No.: US 2012/0113790 A1
(43) Pub. Date: May 10, 2012

(54) Motor and recording disk drive device having the same

(75) Inventors: Tae Young Choi, Yongin (KR); Seung Woo Ha, Suwon (KR); Sang Jin Park, Hwaseong (KR)

(73) Assignee: Samsung Electro-Mechanics Co., Ltd., Suwon (KR)

(21) Appl. No.: 13/064,206

(22) Filed: Mar. 10, 2011

(30) Foreign Application Priority Data
Nov. 8, 2010 (KR) 10-2010-0110582

(51) Int. Cl. H02K 5/167; G11B 21/02

(52) U.S. Cl. 369/215.1; 310/90; G9B/21.003

(57) ABSTRACT

There is provided a motor including: a rotating member coupled to a shaft and rotating in connection with the shaft; a stationary member having the shaft inserted therein and supporting the shaft; a wall part protruding from a surface of the rotating member and allowing oil to be sealed between the rotating member and the stationary member; and a pumping groove formed in at least one of the wall part and an outer surface of the stationary member corresponding to the wall part and pumping the oil between the shaft and the stationary member.

### CROSS-REFERENCE TO RELATED APPLICATIONS

This application claims the priority of Korean Patent Application No. 10-2010-0110582 filed on Nov. 8, 2010, in the Korean Intellectual Property Office, the disclosure of which is incorporated herein by reference.

### BACKGROUND OF THE INVENTION

1. Field of the Invention

The present invention relates to a motor and a recording disk drive device having the same, and more particularly, to a motor including a fluid dynamic bearing assembly and a recording disk drive device having the same.

2. Description of the Related Art

A hard disk drive (HDD) is an information storage device, which uses a read/write head to read data recorded on a disk or write data thereon.

Such an HDD requires a disk drive device capable of driving a disk, and a small spindle motor is used therein.

A small spindle motor uses a fluid dynamic bearing assembly. In the fluid dynamic bearing assembly, oil is provided between a rotating member, i.e., a shaft and a stationary member, i.e., a sleeve. The shaft is supported by fluid pressure generated by the oil. In addition, oil, disposed between the rotating member and the stationary member of the spindle motor, is sealed through a capillary phenomenon and surface tension.

In this case, the oil of the related art spindle motor, adopting this type of oil sealing structure, moves out of a normal oil interface due to oil expansion when temperature is increased by the rotation of the rotating member, which has a harmful effect on the performance of the spindle motor.

That is, in order to maximize the performance of the spindle motor, the amount of oil used therein, the position of an oil interface, and the like, are important. As a result, when the oil is leaked, the characteristics of the motor are degraded.

In particular, when an external impact is applied to a spindle motor, oil leakage may cause more serious problems, which may result in noise, vibrations, non-repeatable run out (NRRO) when the spindle motor is rotated at high speed. As a result, the lifespan of the motor is reduced.

Therefore, research into a small spindle motor in line with the tendency of miniaturization and thinness while maintaining oil sealing even when temperature is increased and an external impact is applied is urgently needed.

### SUMMARY OF THE INVENTION

An aspect of the present invention provides a motor having improved impact resistance and vibration resistance by preventing oil leakage and achieving improved performance and lifespan by being driven at a low level of current and a recording disk drive device including the same.

According to an aspect of the present invention, there is provided a motor including: a rotating member coupled to a shaft and rotating in connection with the shaft; a stationary member having the shaft inserted therein and supporting the shaft; a wall part protruding from a surface of the rotating member and allowing oil to be sealed between the rotating member and the stationary member; and a pumping groove formed in at least one of the wall part and an outer surface of the stationary member corresponding to the wall part and pumping the oil between the shaft and the stationary member.

The pumping groove may have at least one of a spiral shape, a herringbone shape, and a helical shape.

The wall part may be formed along the outer surface of the stationary member such that an oil interface may be formed between the wall part and an upper portion of an outer surface of the stationary member.

The outer surface of the stationary member corresponding to the wall part may be tapered such that a diameter of the stationary member may be reduced downwardly in an axial direction.

The outer surface of the stationary member corresponding to the wall part may have at least one stepped part such that a diameter of the stationary member may be reduced downwardly in an axial direction.

The motor may further include a thrust plate coupled to a lower portion of the shaft and providing a thrust dynamic pressure to the shaft.

The thrust plate may include a thrust dynamic pressure groove in at least one of upper and lower surfaces thereof to provide the thrust dynamic pressure to the shaft.

The thrust dynamic pressure groove may be formed in each of the upper and lower surfaces of the thrust plate, and the thrust dynamic pressure groove formed in the upper surface of the thrust plate may have a spiral shape and the thrust dynamic pressure groove formed in the lower surface of the thrust plate may have a herringbone shape.

The shaft and the thrust plate are coupled to each other by a welding method or a bonding method.

The motor may further include a cover plate coupled to a lower portion of the stationary member in an axial direction having a clearance therebetween.

The cover plate may extend to the outer surface of the stationary member.

The stationary member and the cover plate may be coupled to each other by a welding method or a bonding method.

According to another aspect of the present invention, there is provided a motor including: a hub coupled to a shaft and rotating in connection with the shaft; a sleeve having the shaft inserted therein and supporting the shaft; a thrust plate coupled to a lower portion of the shaft and providing a thrust dynamic pressure to the shaft; a cover plate disposed under the thrust plate and coupled to the sleeve while having a clearance with the shaft; a wall part protruding from a surface of the hub and allowing oil to be sealed between the hub and an upper portion of an outer surface of the sleeve; and a pumping groove formed in at least one of the wall part and the upper portion of the outer surface of the sleeve corresponding to the wall part and pumping the oil between the shaft and the sleeve.

The pumping groove may have at least one of a spiral shape, a herringbone shape, and a helical shape.

The upper portion of the outer surface of the sleeve corresponding to the wall part may be tapered such that a diameter of the sleeve may be reduced downwardly in an axial direction.

The upper portion of the outer surface of the sleeve corresponding to the wall part may have at least one stepped part such that a diameter of the sleeve may be reduced downwardly in an axial direction.

The thrust plate may include a thrust dynamic pressure groove in at least one of upper and lower surfaces thereof to provide the thrust dynamic pressure to the shaft.

The thrust dynamic pressure groove may be formed in each of the upper and lower surfaces of the thrust plate. The thrust dynamic pressure groove formed in the upper surface of the thrust plate may have a spiral shape, and the thrust dynamic pressure groove formed in the lower surface of the thrust plate may have a herringbone shape.

The cover plate may extend to the outer surface of the sleeve.

The shaft and the thrust plate may be coupled to each other by a welding method or a bonding method.

The sleeve and the cover plate may be coupled to each other by a welding method or a bonding method.

According to another aspect of the present invention, there is provided a recording disk drive device including: the motor as described above, the motor rotating a recording disk; ahead transfer unit transferring a head detecting information on the recording disk mounted on the motor to the recording disk; and a housing receiving the motor and the head transfer unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a motor according to an exemplary embodiment of the present invention;

FIG. 2 is a cut-away perspective view schematically showing a hub provided in a motor according to an exemplary embodiment of the present invention;

FIG. 3 is a cross-sectional view schematically showing a motor according to another exemplary embodiment of the present invention;

FIGS. 4A and 4B are a plan view and a bottom view showing a thrust plate provided in a motor according to another exemplary embodiment of the present invention;

FIG. 5 is a cross-sectional view schematically showing a motor according to another exemplary embodiment of the present invention;

FIG. 6 is a cross-sectional view schematically showing a motor according to another exemplary embodiment of the present invention; and

FIG. 7 is a cross-sectional view schematically showing a recording disk drive device, on which a motor according to an exemplary embodiment of the present invention is mounted.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Further, throughout the drawings, the same reference numerals will be used to designate the same or like components.

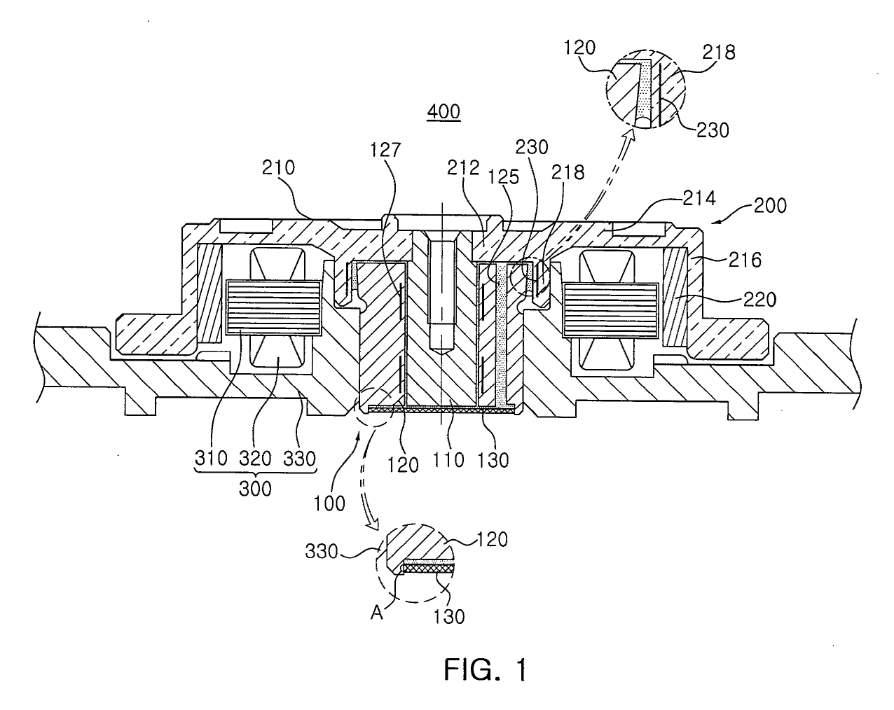

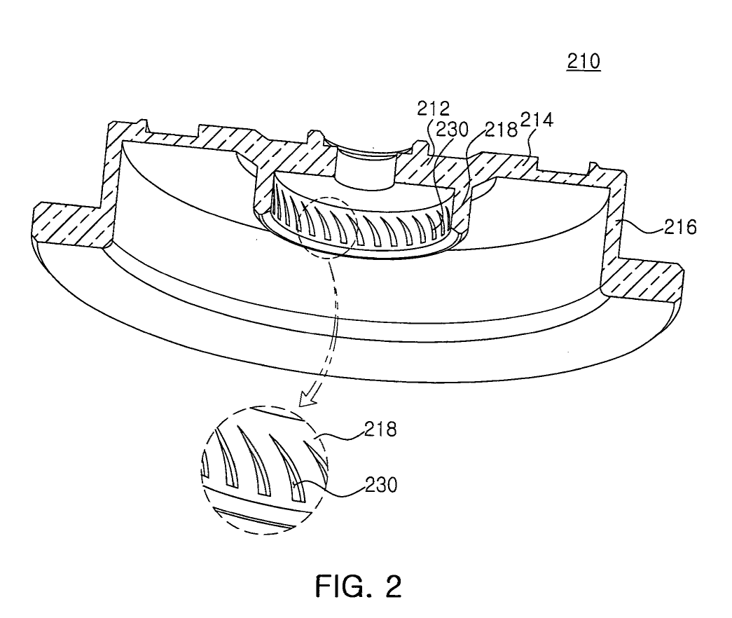

FIG. 1 is a cross-sectional view schematically showing a motor according to an exemplary embodiment of the present invention, and FIG. 2 is a cut-away perspective view schematically showing a hub provided in a motor according to an exemplary embodiment of the present invention.

Referring to FIGS. 1 and 2, a motor 400 according to an exemplary embodiment of the present invention may include a fluid dynamic bearing assembly 100 including a shaft 110 and a sleeve 120, a rotor 200 rotating together with the shaft 110, and a stator 300 including a core 310 around which a coil 320 is wound.

First, terms used herein associated with directions will now be defined. As shown in FIGS. 1, 3, 5, and 6, an axial direction refers to a vertical direction based on the shaft, and a radial direction refers to a direction towards the outer edge of a hub 210 based on the shaft 110 or a central direction of the shaft 110 based on the outer edge of the hub 210.

A sleeve 120 is a stationary member that is coupled to a base member 330, into which the core 310 is fixedly inserted, and supports a rotating member including the shaft 110.

The sleeve 120 may support the shaft 110 so that the upper end of the shaft 110 protrudes upwardly in the axial direction and may be formed by forging Cu or Al or sintering Cu—Fe-based alloy powder or SUS-based powder.

Here, the shaft 110 is inserted into a shaft hole of the sleeve 120 having a micro clearance therebetween. The micro clearance is filled with oil, thereby smoothly supporting the rotation of the rotor 200 by dynamic pressure generated by radial dynamic pressure grooves 127 formed in at least one of an outer diameter portion of the shaft 110 and an inner diameter portion of the sleeve 120.

The radial dynamic pressure grooves 127 may be formed in the inner surface of the sleeve 120, which is the inside of the shaft hole of the sleeve 120, and may generate pressure permitting the shaft to be deflected in a certain direction when the shaft 110 is rotated.

However, the position of the radial dynamic pressure grooves 127 is not limited to the inner surface of the sleeve 120 as described above. The radial dynamic pressure grooves 127 may be provided in the outer diameter portion of the shaft 110. Also, the number of radial dynamic pressure grooves 127 is not particularly limited.

The radial dynamic pressure grooves 127 may have one of a herringbone shape, a spiral shape, and a helical shape; however, the shape thereof is not limited so long as it permits the generation of radial dynamic pressure.

The sleeve 120 is provided with a circulation hole 125 connecting upper and lower portions of the sleeve 120. The circulation hole 125 may distribute the pressure of oil inside the fluid dynamic bearing assembly 100 so as to maintain balance and may cause bubbles or the like, which are present in the fluid dynamic bearing assembly 100, to be discharged by circulation.

Herein, a cover plate 130 may be coupled to the lower portion of the sleeve 120 in the axial direction while maintaining the clearance therebetween, in which the clearance is filled with oil. The clearance between the cover plate 130 and the sleeve 120 is filled with oil, thereby serving as a bearing supporting the bottom surface of the shaft 110.

In addition, the cover plate 130 and the sleeve 120 may be coupled to each other (see A of FIG. 1) by welding or bonding, which may be freely selected in consideration of bonding force, additional processes, and the like.

The rotor 200 is a rotation structure rotatably provided with respect to the stator 300 to be described below. The rotor 200 may include the hub 210 having an annular magnet 220 corresponding to the core 310 with a predetermined interval therebetween along the inner circumferential surface thereof.

In other words, the hub 210 may be a rotating member that is coupled to the upper portion of the shaft 110 to be rotated in connection with the shaft 110.

The magnet 220 may be a permanent magnet having north and south poles alternately arranged in a circumferential direction to generate a predetermined strength of magnetic force.

Further, the hub 210 may include a first cylindrical wall part 212 fixed to the top of the shaft 110, a circular plate part 214 extended outwardly from an edge of the first cylindrical wall part 212 in the radial direction, and a second cylindrical wall part 216 protruding downwardly from an outer edge of the circular plate part 214 in the radial direction. The inner circumferential surface of the second cylindrical wall part 216 may be coupled to the magnet 220.

Further, oil may be sealed between the hub 210 and the upper portion of the outer surface of the sleeve 120. To enable the sealing of oil, a wall part 218 may be formed to be extended downwardly in the axial direction.

The wall part 218 may be formed along the outer surface of the stationary member, i.e., the sleeve 120 such that an oil interface is formed between the wall part 218 and the upper portion of the outer surface of the sleeve 120, i.e., the upper portion of the outer surface of the stationary member.

Here, the oil interface is formed between the stationary member, i.e., the sleeve 120, and the rotating member, i.e., the wall part 218 of the hub 210, such that the generation of sufficient radial dynamic pressure may be achieved as well as miniaturization and thinness may be realized.

In addition, the interval between the wall part 218 and the sleeve 120 is gradually expanded downwardly in the axial direction in order to prevent oil leakage when the motor 400 is driven. To this end, the outer surface of the sleeve 120 corresponding to the wall part 218 may be tapered inwardly in the radial direction.

In other words, the outer surface of the sleeve 120, which is the stationary member corresponding to the wall part 218, may have a diameter gradually reduced downwardly in the axial direction.

Herein, a pumping groove 230 may be formed in the inner circumferential surface of the wall part 218 such that the pumping groove 230 pumps oil towards the oil interface in the case in which the oil moves out of the oil interface due to an external impact or oil expansion according to an increase in temperature. The pumping groove 230 may also be formed in the upper portion of the outer surface of the sleeve 120, i.e., the upper portion of the outer surface of the stationary member, corresponding to the wall part 218.

Herein, as shown in FIG. 2, the pumping groove 230 may be a spiral shape that is an anti-herringbone shape; however, the shape thereof is not limited thereto so long as the shape of the pumping groove may permit the pumping of the oil out of the oil interface in a normal oil interface.

That is, the pumping groove may have a herringbone shape or a helical shape.

Therefore, the pumping groove 230 plays an important role in the motor 400 according to an exemplary embodiment of the present invention that emphasizes the amount of oil and the position of the oil interface. In other words, the pumping groove may minimize noise, vibrations, and non-repeatable run out (NRRO) caused by oil leakage due to an external impact or an increase in temperature, and thus the lifespan of the motor 400 according to the exemplary embodiment of the present invention may be maximized.

The stator 300 is a stationary member in which an insertion hole is formed. The stator 30 may include all the stationary components other than rotating components; however, it may be considered to include the core 310, the coil 320, and the base member 330 for the convenience of explanation.

The stator 300 may be a stationary structure that includes the coil 320 generating a predetermined strength of electromagnetic force when power is applied thereto and the plurality of cores 310 around which the coils 320 are wound.

The cores 310 are fixedly disposed on the upper portion of the base member 330 having a printed circuit board (not shown) on which a circuit pattern is printed. A plurality of coil holes having a predetermined size may be formed to penetrate part of the base member 330 corresponding to the winding coils 320 such that the winding coils 320 are exposed through part of the base member 330. The winding coils 320 are electrically connected to the printed circuit board so that external power is supplied thereto.

The base member 330 may be fixed to the outer surface of the sleeve 120 and may have the cores 310, around which the coils 320 are wound, inserted thereinto. Meanwhile, the base member 330 may be assembled with the sleeve 120 by applying an adhesive to the inner surface of the base member 330 or the outer surface of the sleeve 120.

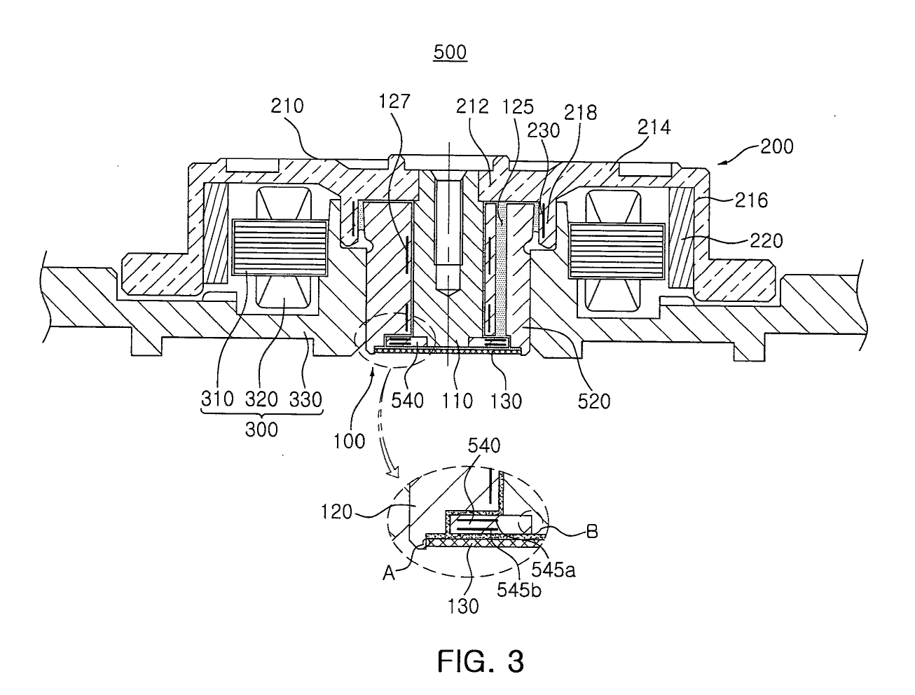

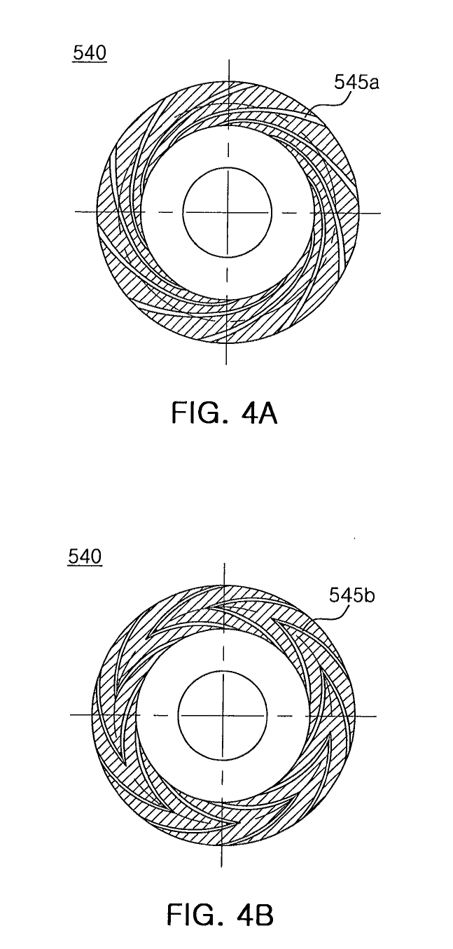

FIG. 3 is a cross-sectional view schematically showing a motor according to another exemplary embodiment of the present invention, and FIGS. 4A and 4B are a plan view and a bottom view showing a thrust plate provided in a motor according to another exemplary embodiment of the present invention.

Referring to FIG. 3, a motor 500 according to another exemplary embodiment of the present invention has the same components and effects as those of the motor 400 according to the aforementioned embodiment of the present invention other than a thrust plate 540. Therefore, a description thereof, other than the thrust plate 540, will be omitted.

The thrust plate 540 is disposed under the sleeve 520 and has a hole, corresponding to the section of the shaft 110, at the center thereof. The shaft 110 is inserted into the hole so that the thrust plate 540 may be coupled to the shaft 110.

Herein, the thrust plate 540 may be separately manufactured and be then coupled to the shaft 110 (see B of FIG. 3) by a welding method or a bonding method.

However, the thrust plate 540 may be, when manufactured, integrally formed with the shaft 110. The thrust plate 540 is rotated along the shaft 110 when the shaft 110 is rotated.

Thrust dynamic pressure grooves 545a and 545b may be formed in upper and lower surfaces of the thrust plate 540, respectively. The thrust dynamic groove 545a provided in the upper surface may have a spiral shape and the thrust dynamic groove 545b provided in the lower surface may have a herringbone shape.

That is, as shown in FIG. 3, in the case in which the circulation hole 125 is formed, the thrust dynamic pressure grooves 545a and 545b may be formed in the upper and lower surfaces of the thrust plate 540 as described above.

In other words, the radial dynamic pressure is generated by the radial dynamic pressure groove 127 formed in the outer circumferential surface of the shaft 110 or the inner circumferential surface of the sleeve 120 and the overall pressure of oil is applied downwardly in the axial direction by the structure of the radial dynamic pressure groove 127.

The pressure moves outwardly in the radial direction of the thrust plate 540, and part of pressure moves upwardly in the axial direction along the circulating hole 125 and the remaining pressure moves downwardly to the lower surface of the thrust plate 540.

Therefore, since part of pressure moves upwardly in the axial direction along the circulation hole 125, a pressure allowing the shaft 110 to lift and rotate is naturally weakened.

Therefore, in order to secure the lifting force of the shaft 110, the thrust dynamic pressure should be supplemented.

For this reason, the thrust dynamic pressure groove may be provided in the lower surface of the thrust plate 540 as well as the upper surface thereof.

However, when the circulation hole 125 is not present, since the loss of pressure along the circulation hole 125 does not occur, the thrust dynamic pressure groove 545a may be only formed in the upper surface of the thrust plate 540 to secure a sufficient lifting force.

However, the thrust dynamic pressure groove 545a may be formed in the lower surface of the sleeve 120 corresponding to the upper surface of the thrust plate 540, rather than in the upper surface of the thrust plate 540 or may be formed in the both surfaces.

In addition, as described above, the thrust dynamic pressure grooves 545a and 545b formed in the upper surface and the lower surface of the thrust plate 540 may have the spiral shape and the herringbone shape, respectively; however, the shape thereof is not limited so long as it permits the generation of thrust dynamic pressure.

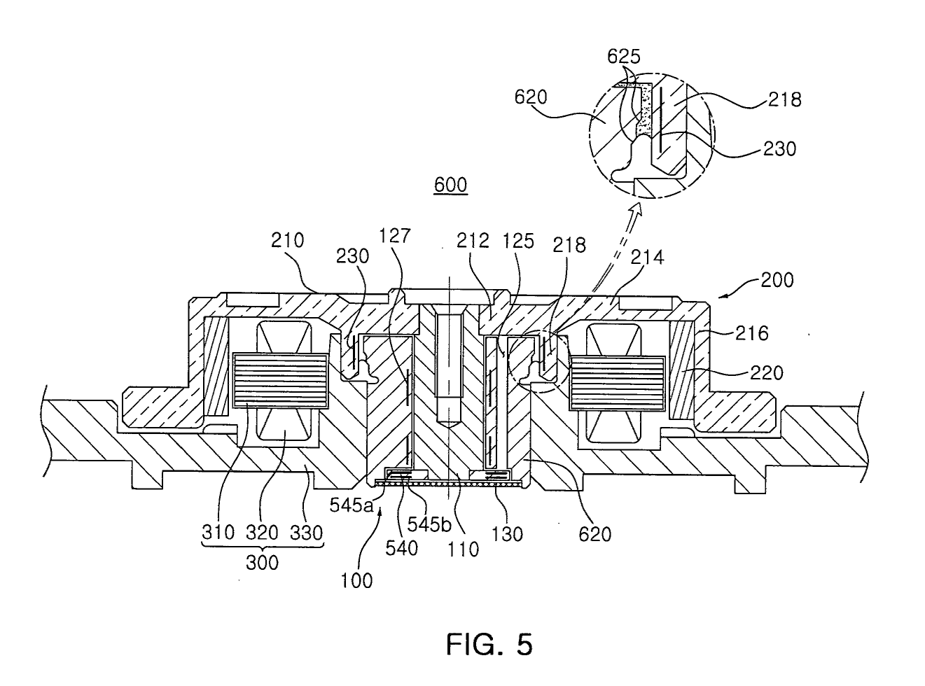

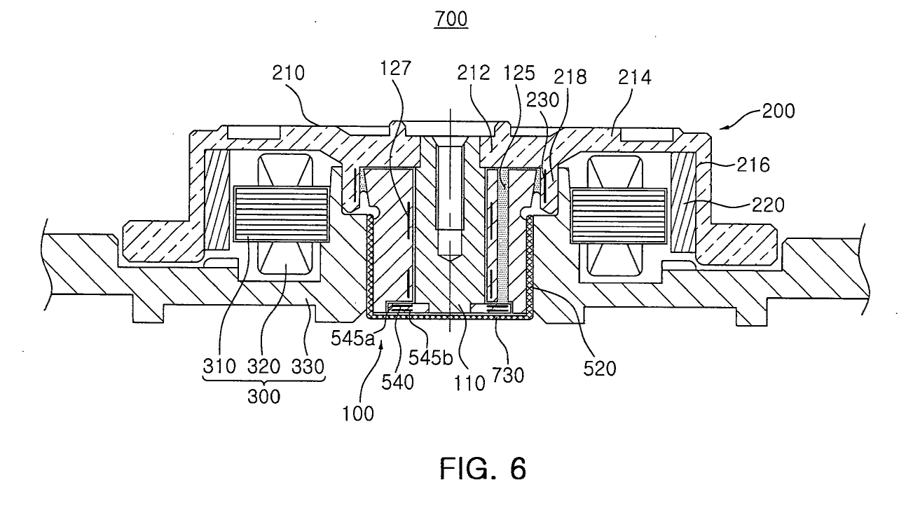

FIGS. 5 and 6 are cross-sectional views schematically showing motors according to another exemplary embodiment of the present invention.

Motors 600 and 700 according to another exemplary embodiment of the present invention shown in FIGS. 5 and 6 have the same components and effects as those of the motor 500 according to the exemplary embodiment of the present invention, other than a sleeve 620 and a cover plate 730. Therefore, a description thereof, other than the sleeve 620 and the cover plate 730, will be omitted.

The sleeve 620 of the motor 600 according to another exemplary embodiment of the present invention, as shown in FIG. 5, may have a stepped part 625 on the upper portion of the outer surface thereof.

That is, since the stepped part 625 is formed on the upper portion of the outer surface of the sleeve 620 that is the stationary member corresponding to the wall part 218 of the hub 210, the sleeve 620 may have a reduced diameter downwardly in the axial direction.

Meanwhile, the number of stepped parts 625 and the width thereof are not limited and may be freely modified so long as they allow the stationary member, i.e., the upper portion of the outer surface of the sleeve 620, to have a reduced diameter downwardly in the axial direction.

An oil interface may be formed between the stepped part 625 and the wall part 218, and the stepped part 625 secures a space capable of storing oil, thereby preventing the oil from being leaked.

In addition, the performance and lifespan of the motor 600 can be maximized by preventing the characteristics of the motor 600 from being degraded due to the oil evaporation.

The cover plate 730 of the motor 700 according to another exemplary embodiment of the present invention, as shown in FIG. 6, may extend to the outer surface of the sleeve 520.

That is, the cover plate 730 is coupled to the outer surface of the sleeve 520. As a coupling method therefor, a bonding method or a welding method may be used.

However, as compared with the motor 500 according to the exemplary embodiment of the present invention, the coupling area between the cover plate 730 and the sleeve 520 may be increased, and accordingly, a sufficient un-mating force may be secured even if the bonding method is used.

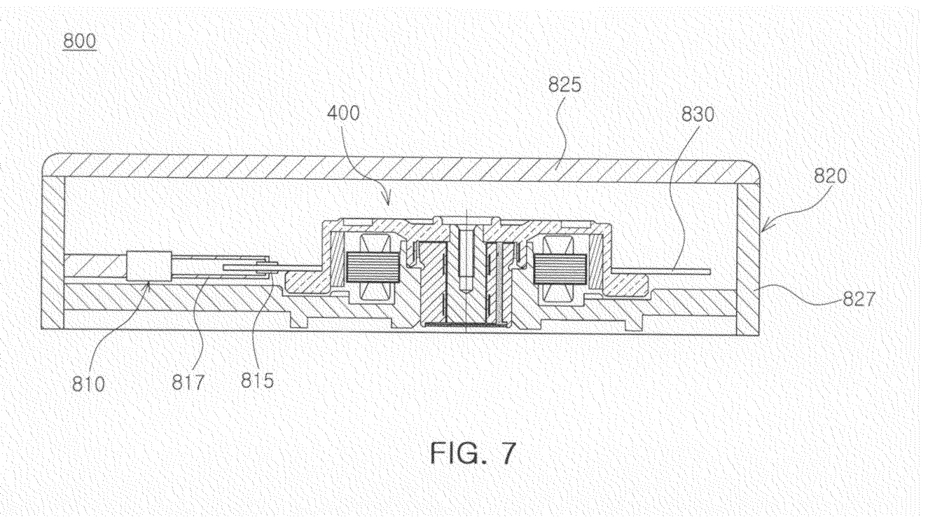

FIG. 7 is a cross-sectional view schematically showing a recording disk drive device on which a motor according to an exemplary embodiment of the present invention is mounted.

Referring to FIG. 7, a recording disk drive device 800, on which the motor 400 according to the exemplary embodiment of the present invention is mounted, may be a hard disk driver and may include the motor 400, a head transfer unit 810, and a housing 820.

The motor 400 may have all the features as described above and may have a recording disk 830 mounted thereon.

FIG. 7 shows the recording disk drive device 800 including the motor 400 according to the exemplary embodiment of the present invention; however, the invention is not limited thereto. The motor mounted on the recording disk drive device 800 may be one of the above-mentioned motors 500, 600, and 700.

The head transfer unit 810 may transfer a head 815, which detects information on the recording disk 830 mounted on the motor 400, to a surface of the recording disk 830 to be detected.

Here, the head 815 may be disposed on a support 817 of the head transfer unit 810.

The housing 820 may include a motor-mounted plate 827 and a top cover 825 shielding an upper portion of the motor-mounted plate 927 in order to form an internal space receiving the motor 400 and the head transfer unit 810.

The motor 400, 500, 600, and 700 according to the exemplary embodiments of the present invention includes the pumping groove 230 in the wall part 218 of the hub 210 to thereby prevent oil from being leaked due to an increase in temperature and an external impact, whereby the performance and lifespan thereof may be improved.

In addition, the upper portion of the outer surface of the stationary member, i.e., the sleeve 120 and 520, has a reduced diameter downwardly in the axial direction, whereby the storage amount of oil may be sufficiently secured.

Further, an oil interface is formed between the stationary member, the sleeve 120 and 520 and the rotating member, the wall part 218 of the hub 210, whereby the generation of a sufficient radial dynamic pressure as well as pursuing miniaturization and thinness may be achieved.

As set forth above, in a motor and a recording disk drive device including the same according to exemplary embodiments of the present invention, oil leakage caused due to the rising of temperature and an external impact can be prevented so that the performance of the motor can be enhanced.

In addition, the lifespan of the motor can be maximized by securing the storage amount of oil. The generation of a sufficient radial dynamic pressure as well as the miniaturization and thinness of the motor can be achieved.

While the present invention has been shown and described in connection with the exemplary embodiments, it will be apparent to those skilled in the art that modifications and variations can be made without departing from the spirit and scope of the invention as defined by the appended claims.

What is claimed is:

1. A motor comprising:
a rotating member coupled to a shaft and rotating in connection with the shaft;
a stationary member having the shaft inserted therein and supporting the shaft;
a wall part protruding from a surface of the rotating member and allowing oil to be sealed between the rotating member and the stationary member; and
a pumping groove formed in at least one of the wall part and an outer surface of the stationary member corresponding to the wall part and pumping the oil between the shaft and the stationary member.

2. The motor of claim 1, wherein the pumping groove has at least one of a spiral shape, a herringbone shape, and a helical shape.

3. The motor of claim 1, wherein the wall part is formed along the outer surface of the stationary member such that an oil interface is formed between the wall part and an upper portion of an outer surface of the stationary member.

4. The motor of claim 1, wherein the outer surface of the stationary member corresponding to the wall part is tapered such that a diameter of the stationary member is reduced downwardly in an axial direction.

5. The motor of claim 1, wherein the outer surface of the stationary member corresponding to the wall part has at least one stepped part such that a diameter of the stationary member is reduced downwardly in an axial direction.

6. The motor of claim 1, further comprising a thrust plate coupled to a lower portion of the shaft and providing a thrust dynamic pressure to the shaft.

7. The motor of claim 6, wherein the thrust plate includes a thrust dynamic pressure groove in at least one of upper and lower surfaces thereof to provide the thrust dynamic pressure to the shaft.

8. The motor of claim 7, wherein the thrust dynamic pressure groove is formed in each of the upper and lower surfaces of the thrust plate, and
the thrust dynamic pressure groove formed in the upper surface of the thrust plate has a spiral shape and the thrust dynamic pressure groove formed in the lower surface of the thrust plate has a herringbone shape.

9. The motor of claim 6, wherein the shaft and the thrust plate are coupled to each other by a welding method or a bonding method.

10. The motor of claim 1, further comprising a cover plate coupled to a lower portion of the stationary member in an axial direction having a clearance therebetween.

11. The motor of claim 10, wherein the cover plate extends to the outer surface of the stationary member.

12. The motor of claim 10, wherein the stationary member and the cover plate are coupled to each other by a welding method or a bonding method.

13. A motor comprising:
a hub coupled to a shaft and rotating in connection with the shaft;
a sleeve having the shaft inserted therein and supporting the shaft;
a thrust plate coupled to a lower portion of the shaft and providing a thrust dynamic pressure to the shaft;
a cover plate disposed under the thrust plate and coupled to the sleeve while having a clearance with the shaft;
a wall part protruding from a surface of the hub and allowing oil to be sealed between the hub and an upper portion of an outer surface of the sleeve; and
a pumping groove formed in at least one of the wall part and the upper portion of the outer surface of the sleeve corresponding to the wall part and pumping the oil between the shaft and the sleeve.

14. The motor of claim 13, wherein the pumping groove has at least one of a spiral shape, a herringbone shape, and a helical shape.

15. The motor of claim 13, wherein the upper portion of the outer surface of the sleeve corresponding to the wall part is tapered such that a diameter of the sleeve is reduced downwardly in an axial direction.

16. The motor of claim 13, wherein the upper portion of the outer surface of the sleeve corresponding to the wall part has at least one stepped part such that a diameter of the sleeve is reduced downwardly in an axial direction.

17. The motor of claim 13, wherein the thrust plate includes a thrust dynamic pressure groove in at least one of upper and lower surfaces thereof to provide the thrust dynamic pressure to the shaft.

18. The motor of claim 17, wherein the thrust dynamic pressure groove is formed in each of the upper and lower surfaces of the thrust plate, and
the thrust dynamic pressure groove formed in the upper surface of the thrust plate has a spiral shape and the thrust dynamic pressure groove formed in the lower surface of the thrust plate has a herringbone shape.

19. The motor of claim 13, wherein the cover plate extends to the outer surface of the sleeve.

20. The motor of claim 13, wherein the shaft and the thrust plate are coupled to each other by a welding method or a bonding method.

21. The motor of claim 13, wherein the sleeve and the cover plate are coupled to each other by a welding method or a bonding method.

22. A recording disk drive device comprising:
the motor of claim 1 rotating a recording disk;
a head transfer unit transferring a head detecting information on the recording disk mounted on the motor to the recording disk; and
a housing receiving the motor and the head transfer unit.

23. A recording disk drive device comprising:
the motor of claim 13 rotating a recording disk;
a head transfer unit transferring a head detecting information on the recording disk mounted on the motor to the recording disk; and
a housing receiving the motor and the head transfer unit.
